(19) United States
(12) Patent Application Publication
(10) Pub. No.: US 2012/0124080 A1
(43) Pub. Date: May 17, 2012

(54) METHOD, APPARATUS AND COMPUTER PROGRAM PRODUCT FOR UTILIZING DYNAMICALLY DEFINED JAVA IMPLEMENTATIONS FOR CREATION OF AN EFFICIENT TYPED STORAGE

(75) Inventors: Keith Willard, St. Paul, MN (US); Rick Spates, Canton, GA (US); Michael Altmann, Minneapolis, MN (US)

(73) Assignee: McKesson Financial Holdings Limited

(21) Appl. No.: 12/947,425

(22) Filed: Nov. 16, 2010

(51) Int. Cl. G06F 17/30

(52) U.S. Cl. 707/769; 707/803; 707/E17.014; 707/E17.045

(57) ABSTRACT

A method for providing a patient quality monitor may include transforming patient data from a plurality of sources associated with different healthcare entities into a standard representation using a mapping to tag each piece of patient data to a common ontology, mapping the standard representation to corresponding Java class implementations, and mapping the corresponding Java class implementations to a relational database. A corresponding computer program product and apparatus are also provided.

### TECHNOLOGICAL FIELD

Embodiments of the present invention relate generally to health care management solutions and, more particularly, relate to a mechanism for utilizing dynamically defined Java implementations for creation of an efficient typed storage.

### BACKGROUND

Many aspects of the provision of medical care and the management of many aspects of the healthcare system now involve the use of computers and computer applications. For example, recent efforts have been made to move to electronic medical records (EMR). With clinical documentation systems moving to electronic media, clinical data may be available for incorporation into a number of different applications designed to assist in the management or use of such data. Computerized provider order entry (CPOE) is another example of a development that may improve the ability to electronically access information related to physician's orders. Many other applications are also being developed to utilize electronic information on people and processes to manage the provision of various aspects of patient care including the provision of predictive care.

As is to be expected, the demand for applications that can be used for streamlining the provision of health care services and the management of health care-related information has led to the development of many new applications by many different providers. However, given the massive amount of data for which storage is desirable, and given also that much of the data is entered in different ways or under different ontological conventions at various different locations, it has often become necessary for the applications that are written to perform the service and management functions to be tailored to specific institutions. Thus, the performance of analytics on data sets of electronic clinical data associated with specific organizations may require specifically tailored software applications, which increases cost.

### BRIEF SUMMARY

A method, apparatus and computer program product are therefore provided to enable the provision of dynamically defined Java implementations for creation of an efficient typed storage. Moreover, some embodiments may provide a strongly typed mapping to a persistent storage table framework.

In one example embodiment, a method for utilizing dynamically defined Java implementations for creation of an efficient typed storage is provided. The method may include transforming patient data from a plurality of sources associated with different healthcare entities into a standard representation using a mapping to tag each piece of patient data to a common ontology, mapping the standard representation to corresponding Java class implementations, and mapping the corresponding Java class implementations to a relational database.

In another example embodiment, a computer program product for utilizing dynamically defined Java implementations for creation of an efficient typed storage is provided. The computer program product may include at least one computer-readable storage medium having computer-executable program code instructions stored therein. The computer-executable program code instructions may include program code instructions for transforming patient data from a plurality of sources associated with different healthcare entities into a standard representation using a mapping to tag each piece of patient data to a common ontology, mapping the standard representation to corresponding Java class implementations, and mapping the corresponding Java class implementations to a relational database.

In another example embodiment, an apparatus for utilizing dynamically defined Java implementations for creation of an efficient typed storage is provided. The apparatus may include processing circuitry. The processing circuitry may be configured for transforming patient data from a plurality of sources associated with different healthcare entities into a standard representation using a mapping to tag each piece of patient data to a common ontology, mapping the standard representation to corresponding Java class implementations, and mapping the corresponding Java class implementations to a relational database.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for utilizing dynamically defined Java implementations for creation of an efficient typed storage according to an example embodiment of the present invention;

FIG. 2 shows an example message that may be used to provide data to a fact repository;

FIG. 3 is a block diagram showing various components that may be included in an apparatus for utilizing dynamically defined Java implementations for creation of an efficient typed storage according to an example embodiment of the present invention;

FIG. 4 illustrates an example of the use of metadata corresponding to a resource description framework model to construct corresponding Java beans using a bean factory according to an example embodiment of the present invention;

FIG. 5 illustrates a Unified Modeling Language (UML) diagram of a Java class hierarchy down to the term “intubated” according to an example embodiment of the present invention;

FIG. 6 illustrates a mapping of Java beans to normal Structured Query Language (SQL) tables according to an example embodiment of the present invention;

FIG. 7 illustrates an example SQL query for intubated patients according to an example embodiment of the present invention;

FIG. 8 illustrates a block diagram of a hybrid triple/Java bean in-memory architecture according to an example embodiment of the present invention; and

FIG. 9 is a block diagram according to an example method for utilizing dynamically defined Java implementations for creation of an efficient typed storage according to an example embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which dynamically defined Java implementations may be used for creation of an efficient typed storage. Moreover, some embodiments may provide a strongly typed mapping to a persistent storage table framework. In some embodiments, a technique for dynamically deriving a Java bean class layer over a Resource Description Framework/Web Ontology Language (RDF/OWL) T-box (terminology box) ontology model for clinical knowledge and extending the semantics of the RDF/OWL T-box to include the strongly typed mapping to a persistent Structured Query Language (SQL) storage table framework is provided. This approach may leverage dynamic construction of java classes, and dynamic mapping of class hierarchies to a small set of SQL tables in which the core properties are all defined in a strongly typed form both at the java class and SQL table column level.

Some conventional persistent storage models for an assertion box (A-box) of RDF/OWL may depend on heavily “untyped” persistent data representations. SDB in the Jena API is a good example of this approach. Database representations that have dependencies on untyped persistent data representations may be convenient for working with a wide range of T-box instances and may be useful for simple bulk loading kinds of retrieval. However, such database representations may be highly inefficient in more complex queries. The robustness of such representations over the details of the kinds typing inherent in the model makes the model perform less efficiently than some non-RDF database schema. As an example, practical clinical use of such data requiring temporal queries whose efficient implementation depends on indexed date columns used in the WHERE clause often cannot be performed at the database tier where it is not known whether a property is a date or a string.

For all practical purposes this means conventional RDF SQL persistent storage typically requires loading all the data into memory before applying WHERE clause constraints. This may be a difficult strategy to scale as the size of the data can get beyond that which practical machines can load into in-memory models in transaction systems where querying performance is critical.

The use of a specific ontology (a T-box), as provided in connection with some example embodiments described in greater detail below, may make it possible to map ontology semantics onto a superset of Unified Modeling Language (UML) semantics and then use the metadata associated therewith to construct ontology dependent Java classes with the appropriate structural characteristics. Instances of the Java classes may correspond to the A-box world of triples for that RDF/OWL ontology. Given these defined classes, it may then be possible to map the classes to strongly typed columns in a wide table for the majority of ontology types. The classes may form the basis of a programmatically friendly interface to the RDF/OWL ontology. The classes may also form the basis for a persistent longitudinal storage in tables that may be out of the box ready for conventional reporting uses in which the properties of the T-box ontology are fully exposed as strongly typed columns enabling efficient and transparent query operation.

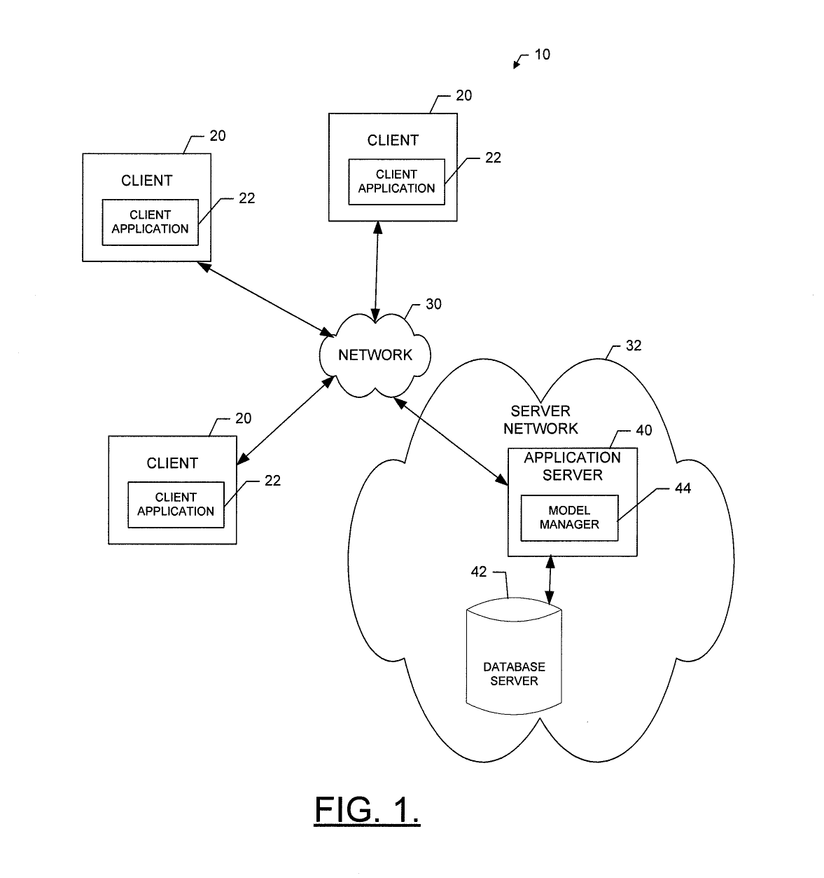

An example embodiment of the invention will now be described in reference to FIG. 1, which illustrates an example system in which an embodiment of the present invention may be employed. As shown in FIG. 1, a system 10 according to an example embodiment may include one or more clients 20 that may, in some cases, be associated with different corresponding units, wings or departments of a hospital or healthcare system. For example, one client 20 may be associated with a first hospital unit (e.g., an intensive care unit (ICU)) and a second client 20 may be associated with a second hospital unit (e.g., a respiratory therapy unit). However, information associated with multiple units may alternatively be accessible via a single client. Furthermore, in some cases, multiple clients may be associated with the same unit. For example, clients 20 could be located at nurse's stations, at various locations in hallways within a treatment unit or even within patient rooms. In still other examples, the clients 20 may be associated with different entities of different healthcare systems or different regional healthcare related entities.

Each client 20 may be, for example, a computer (e.g., a personal computer, laptop computer, network access terminal, or the like) or may be another form of computing device (e.g., a personal digital assistant (PDA), cellular phone, or the like) capable of communication with a network 30. As such, for example, each client 20 may include (or otherwise have access to) memory for storing instructions or applications for the performance of various functions and a corresponding processor for executing stored instructions or applications. Each client 20 may also include software and/or corresponding hardware for enabling the performance of the respective functions of the clients as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for the provision of and receipt of information associated with clinical data and/or for the performance of analytics or other processing of the clinical data. As such, for example, the client application 22 may include corresponding executable instructions for configuring the client 20 to provide corresponding functionalities for the provision of and receipt of information associated with providing the clinical data and/or processing the clinical data as described in greater detail below.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an example embodiment, one of the devices to which the clients 20 may be coupled via the network 30 may include one or more application servers (e.g., application server 40), and/or a database server 42, which together may form respective elements of a server network 32. Although the application server 40 and the database server 42 are each referred to as “servers”, this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the transformation and modeling operations described herein for transforming clinical data received at the application server 40 into a universal ontology or standard representation and/or for mapping the standard representation to corresponding Java class implementations and mapping the corresponding Java class implementations to a relational database. In some embodiments, for example, the application server 40 may include a model manager 44 comprising stored instructions for handling activities associated with practicing example embodiments as described herein.

Additionally or alternatively, the application server 40 may be configured to enable the clients 20 to provide information to the application server 40, for use by the application server 40 in producing, maintaining and/or supplying the clinical data in a strongly typed format to assist in responding to queries. In this regard, for example, the application server 40 (or servers) may include particular applications related to various different clinical data entry, management and/or storage modules. As such, some application servers may host data entry mechanisms that enable the entry of patient information, treatment information, test results, medical history, orders, medications, and numerous other types of information for storage in the database server 42. In other words, the database server 42 may form a fact repository to accept core clinical data updates of observations, medication administrations, intravenous (IV) administrations, orders and other similar data that may be provided in the context of an EMR or other hospital or healthcare system electronic data gathering and/or storage regimes.

In one embodiment, the fact repository may enhance patient data through associations with clinical concepts to form structured data. As a result of the associations with clinical concepts, the fact repository, which may in some cases include a processor and memory for enabling processing and storage, may process the patient data in various manners, such as by transforming the patient data to a standard representation. For example, in instances in which the data represents the patient's temperature, the fact repository may be configured to transform the temperature from a simple string representation, such as 101.9 F, to a strongly-typed internal, floating-point representation of the value. Through associations with clinical terms and rules related to the clinical terms, the fact repository may also determine one or more attributes associated with the transformed value. For example, the fact repository may, in the foregoing example, compare the transformed temperature value to a normal range of temperature values and determine if the patient's temperature is high, normal or low. These attributes may then be stored along with or otherwise in association with the patient data.

The fact repository and the clinical process driver may then process the structured data in accordance with rules associated with clinical concepts in order to further characterize and specify the nature of the patient data. For example, the fact repository, in conjunction with the clinical process driver, may be configured to determine trends with respect to the patient data. The definition of a trend may be dependent upon the type of patient data. For example, with respect to body temperature, three consecutive body temperature recordings above the normal range within the preceding 12 hours may define a trend that creates an additional clinical fact that may be stored in addition to the underlying patient data.

As indicated above, the fact repository may also include memory for storing the patient data, attributes related to the patient data and clinical facts that are created by analysis of the patient data. While the patient data may be stored within the memory of the fact repository while and at least shortly after the patient data is processed by the processor of the fact repository, other storage devices may also be provided, such as random access memory.

In an example embodiment, the application server 40 may include or have access to memory (e.g., internal memory or the database server 42) for storing instructions or applications for the performance of various functions and a corresponding processor for executing stored instructions or applications. In an example embodiment, the application server 40 may include the model manager 44 configured to operate in accordance with an example embodiment of the present invention. In this regard, for example, the model manager 44 may include software for enabling the application server 40 to communicate with the network 30 and/or the clients 20 for the provision and/or receipt of information associated with providing persistent storage of data that is accessible for querying via a user friendly interface to the standard representation (or universal ontology). As such, for example, the client application 22 may include corresponding executable instructions for configuring the client 20 to request information (e.g., via the model manager 44) regarding one or more patients to enable the presentation of the information at the client 20. The model manager 44 may therefore be configured to provide corresponding functionalities for the provision and/or receipt of information associated with providing the requested information as described in greater detail below.

As indicated above, the database server 42 may act as a fact repository for electronically recorded clinical data regarding various activities performed with respect to a particular patient. In an example embodiment, the clinical data that is written to the database server 42 may be mapped to a core-clinical ontology providing a framework for classifying the data. For example, a life-sciences ontology may be employed to provide a target representation of data for use in a patient quality monitor application. The core-clinical data may be transformed to a structured, strongly-typed form and represented as instances within the life-sciences model. Once transformed, the instances may be rationalized based on attributes such as normal, abnormal, outside normal range, within normal range, or other applicable attributes. Transformed and rationalized data may then be stored in the database server 42. In an example embodiment, the database server 42 may comprise a long-term, persistent triple data store (TDS) that may be available for sending data to other applications as strongly-typed items. Alternatively or additionally, the data stored in the database server 42 may be available for querying or searching and reporting or driving applications. Once posted to the TDS, data can trigger or otherwise be used in connection with rule processing, including potentially complex rule processing, based on trigger mappings within the life-sciences model. As such, for example, a particular condition may be monitored by setting up rules that extract specific data from the database server 42 for use in one or more analytic programs.

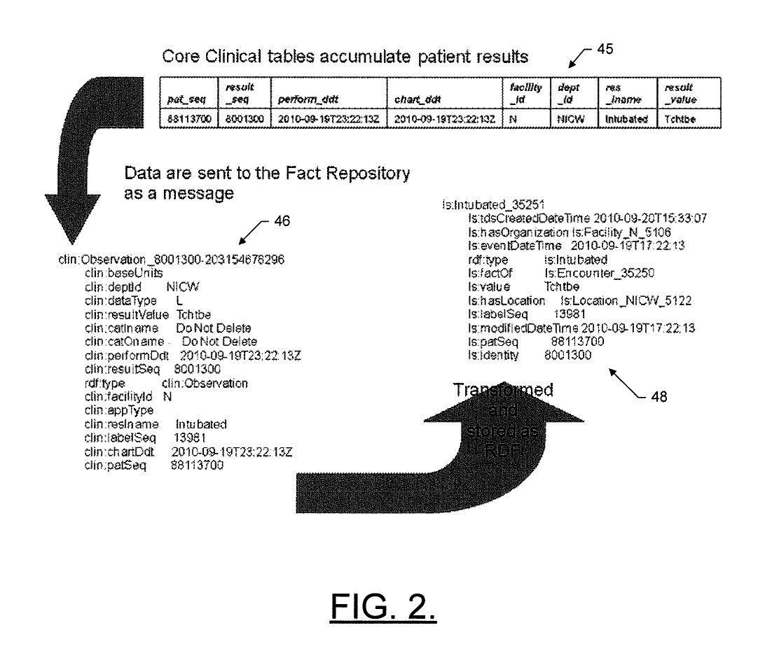

In an example embodiment, data may be sent to the fact repository as a message, as illustrated in FIG. 2. In this regard, a core clinical table 45 with accumulated patient results may be sent to the fact repository as message 46. The message may be transformed (e.g., by the application server 40 as described above) to be stored as normalized RDF data 48. By providing for the transformation of terms that enter the system like the message 46 into normalized RDF data, a common clinical parlance may be created via the standard representation offered by the normalized RDF. Thus, each hospital or entity associated with the different clients 20 may use their own individual terminology, but the diverse terminologies used by each of the clients 20 may be converted into a universal ontology. Accordingly, the application server 40 may map various hospital terms to a common term that can be recognized and used by the model manager 44. Example embodiments therefore provide for the mapping of clinical terms to a RDF T-box term that is common to the various different terminologies used by different entities that provide data into the system. For example, for the term “intubated,” many different entities may use different terminology to indicate the status of “intubated.” The application server 40 may be able to, at runtime, transform the data provided by any client into a standardized intubation fact that can be stored in the fact repository.

Although the fact repository may store a plurality of standardized facts associated with clinical data received thereat, the typical mechanism for storing such data is not accessible for use to respond to SQL queries. Thus, all data in the persistent back end would need to be loaded into memory to enable queries to be performed there. Some example embodiments of the present invention may employ the model manager 44 to provide for a mechanism by which to bridge the accessibility shortcomings described above. Moreover, some embodiments may also publish transformed events to other applications in a given clinical environment in real time.

In an example embodiment, the model manager 44 may be configured to utilize specific T-box metadata to construct an equivalent data container works to the standard representation or universal ontology instance that is implemented by normal Java classes. As such, the model manager 44 may be configured to manage the mapping of these Java classes, e.g., via object relational mapping libraries, to a SQL table in order to enable querying over a specific T-box using SQL that can be embedded into various report generation tools. Because the SQL columns are type specific and not generic (as is the case for typical RDF storage tables), the SQL database's WHERE clause query optimizations may be leveraged in the database tier rather than having to first pull those entities into memory, convert them into their respective types, and then do in-memory iterations over large collections in order to find particular entities. For complex queries, relatively higher performance and tunable query performance from the SQL tier may be achieved as compared to an in-memory SPARQL Protocol and RDF Query Language (SPARQL) query.

In some example embodiments, the model manager 44 may be configured to map the universal ontology or standard representation to corresponding Java class implementations (e.g., Java beans) so that the Java beans can be mapped to a relational database. By exposing specific instances of the ontology (the A-box) as Java beans, which are a relatively standard tool in the programming world, the RDF may be made more programmatically friendly to potential users (or re-users) of the system. As such, the model manager 44 may be configured to adapt the RDF world to the Java world so that pre-existing architectural knowledge (and perhaps also bias) associated with Java programming may be leveraged advantageously. Thus, the model manager 44 may be configured to enable movement from the Jena world of triples of facts in the fact repository to the Java bean world of facts.

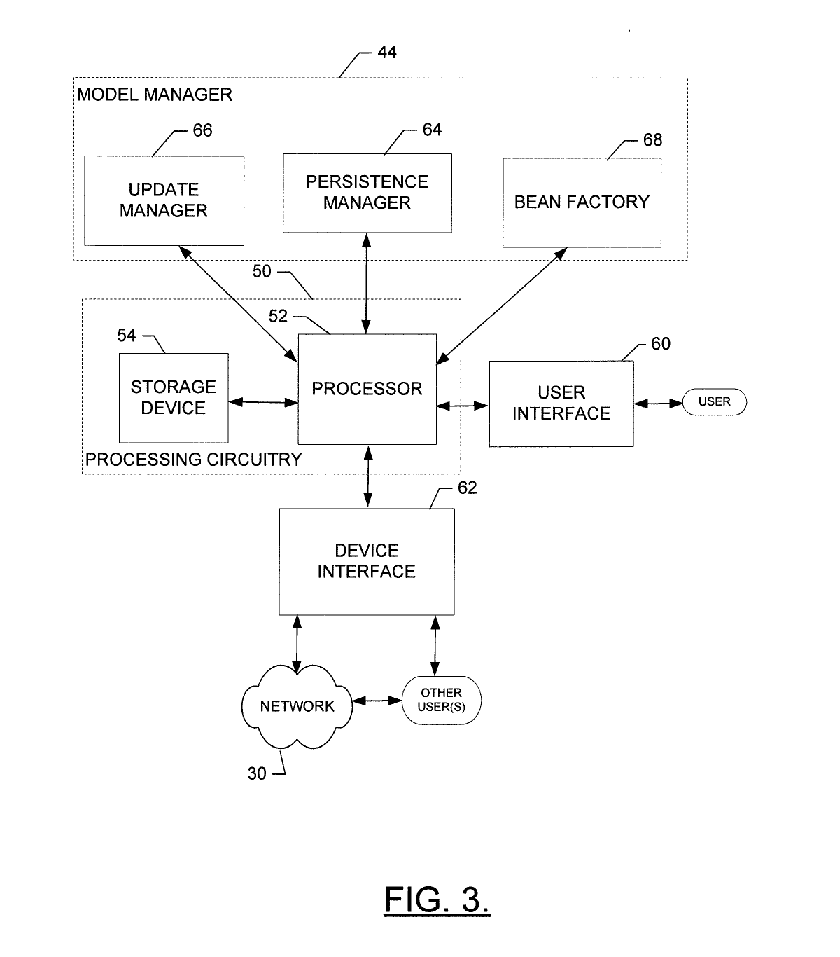

An example embodiment of the invention will now be described with reference to FIG. 3. FIG. 3 shows certain elements of an apparatus for utilizing dynamically defined Java implementations for creation of an efficient typed storage according to an example embodiment. The apparatus of FIG. 3 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40) or by devices in a client/server relationship (e.g., the application server 40 and one or more clients 20). Furthermore, it should be noted that the devices or elements described below may not be mandatory and thus some may be omitted in certain embodiments.

Referring now to FIG. 3, an apparatus for utilizing dynamically defined Java implementations for creation of an efficient typed storage is provided. The apparatus may include or otherwise be in communication with processing circuitry 50 that is configured to perform data processing, application execution and other processing and management services according to an example embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 22) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or model manager 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the model manager 44, which may include or otherwise control a persistence manager 64, an update manager 66 and a bean factory 68. The persistence manager 64, the update manager 66 and the bean factory 68 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the persistence manager 64, the update manager 66 and the bean factory 68, respectively, as described below.

The persistence manager 64 may be configured to provide, at runtime, for mapping of data from the Jena world of triples of facts to the Java bean world of facts, and the update manager 66 may be configured to provide for mapping of data in the reverse direction (e.g., from the bean world to the world of triples of facts). The fact repository may therefore include memory cached environments that can be queried for special services, while the bean world of facts may map to and from a database management system such as Oracle using a rules engine that runs against the bean world. Meanwhile, the bean factory 68 may be configured to create a Java class hierarchy that corresponds to the clinical concept tree hierarchy of the RDF ontology framework.

Metadata that is available in the T-box may be used to create a solution (at runtime) that allows mapping of relevant concepts to a specifically typed persistence environment (e.g., an SQL persistence environment). To accomplish the mapping, a set of Java beans that include the information that is described by a particular triple defined by a specific T-box that represents the universal ontology or standard representation of concepts may be employed. The universal ontology may be universal across any entity that may be associated with one of the clients 20 of FIG. 1.

An RDF ontology may be viewed as a superset of a unified modeling language (UML) in that the RDF ontology contains metadata to describe a graph of entities (classes) that may each have a set of properties and types (e.g., classes or primitive types). RDF generally defines a set of primitive types that are described with extensible markup language (XML) schema definition (XSD). This may be leveraged to map the types to Java primitives in the Java world. Accordingly, ontology classes may be mapped to Java classes. In some cases, type restrictions and so-called dictionary types may be handled with specialized procedures via a general RDF type to Java class correlation provided by the bean factory 68.

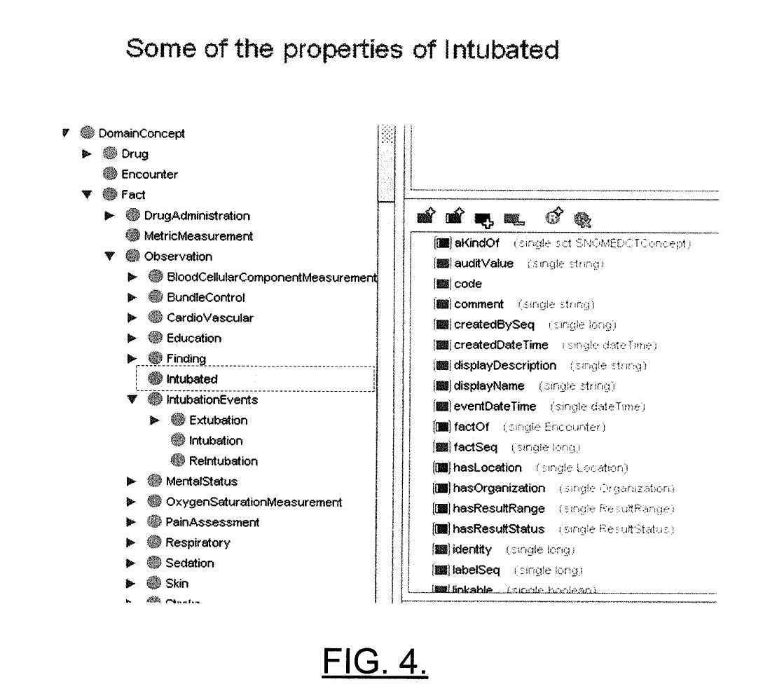

FIG. 4 illustrates an example of the use of metadata corresponding to an RDF model to construct corresponding Java beans using the bean factory 68. In this regard, FIG. 4 is an example of a screenshot of a hierarchical tree for an RDF ontology on the left side of the page. As can be seen in FIG. 4, the term “intubated” has been highlighted from the RDF ontology. The right side of the page then shows corresponding Java beans for a Java intubation type. The inheritance hierarchy implied in the RDF world (e.g., where intubated is a subclass of Observation, which is a subclass of Fact, which is a subclass of DomainConcept) may be used to create a Java class hierarchy. Thus, for the “intubated” RDF type, which is represented as a member of the T-box as an ontology type, a corresponding group of properties may be modeled to hold the information that can be expected to be derived from the system at runtime, and the bean factory 68 maps the ontology type to corresponding Java beans.

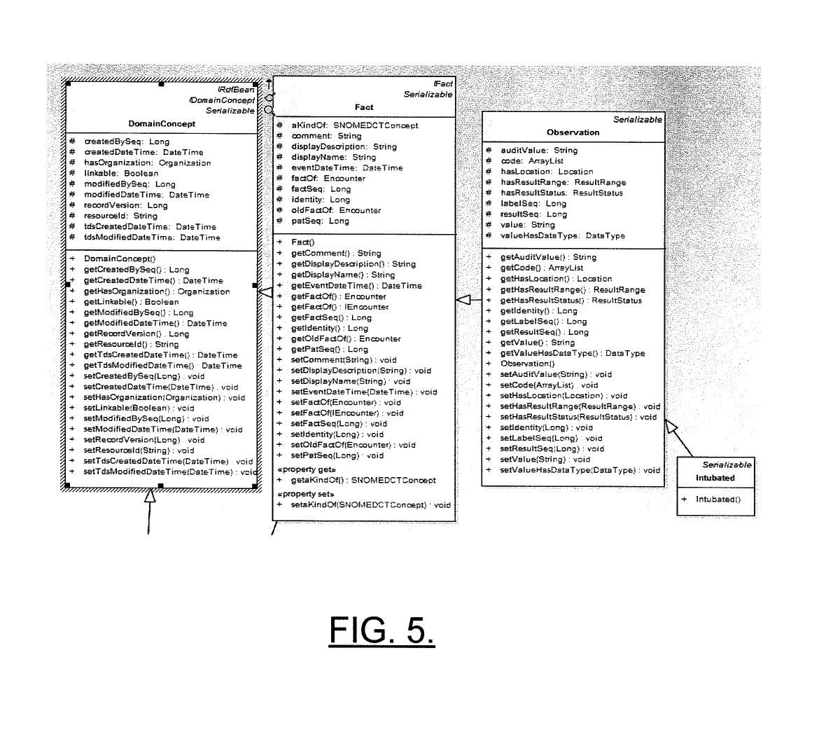

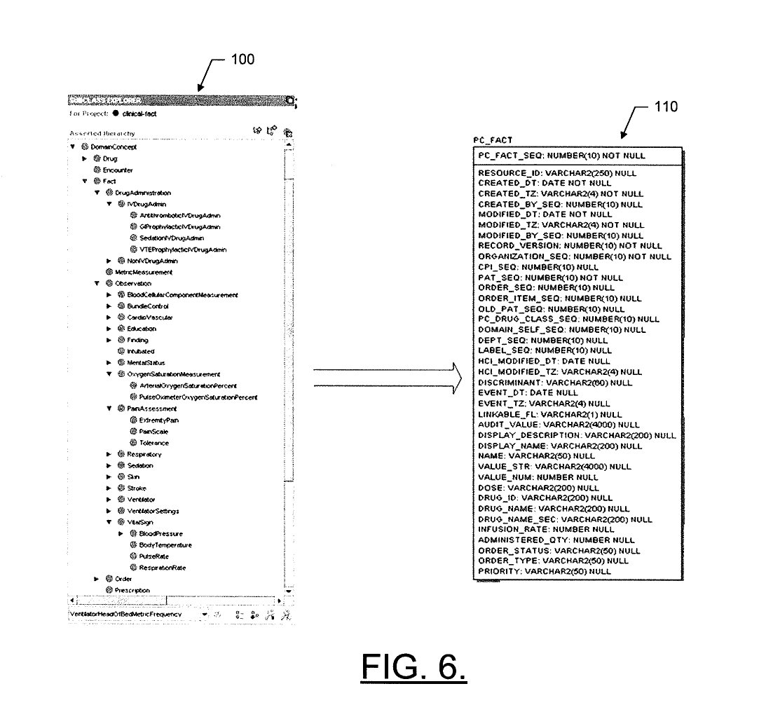

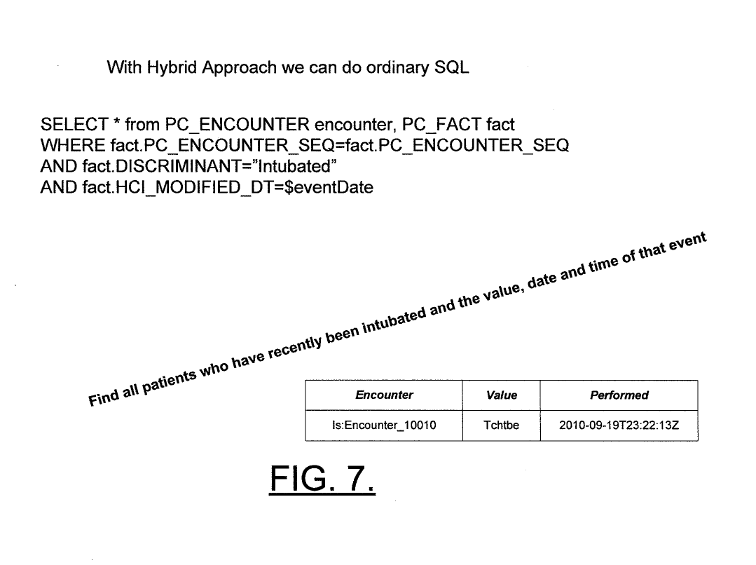

Some example embodiments create the class hierarchy at runtime (rather than at development time). In some cases, a Javassist framework may be used to dynamically create class definitions with runtime bytecode generators. Given a set of normal Java bean class definitions, the classes can be mapped (e.g., via an object relational framework such as Hibernate or JPA) to conventional SQL tables as shown in FIG. 5. In this regard, FIG. 5 illustrates a UML diagram of a Java class hierarchy down to “intubated.” FIG. 6 illustrates a mapping of Java beans to normal SQL tables according to an example embodiment. In this regard, FIG. 6 shows a fact ontology hierarchy 100 that includes the “intubated” subclass of Observation being mapped to the SQL table 110. The SQL table is “normal” with its value and date columns, for example, being fully exposed (unlike SQL tables that typically store triples). Accordingly, SQL queries may be implemented to accomplish the goal of finding information about patients in a typical way. FIG. 7 illustrates an example SQL query for intubated patients. The query of FIG. 7 may be run against the table shown in FIG. 6. The query of FIG. 7 is a relatively simple SQL query and, since datetime operations are explicit, the query format is fully useable in a database having WHERE clause restrictions. Moreover, unlike a conventional SPARQL query, the example query of FIG. 7 could be built into any report writer.

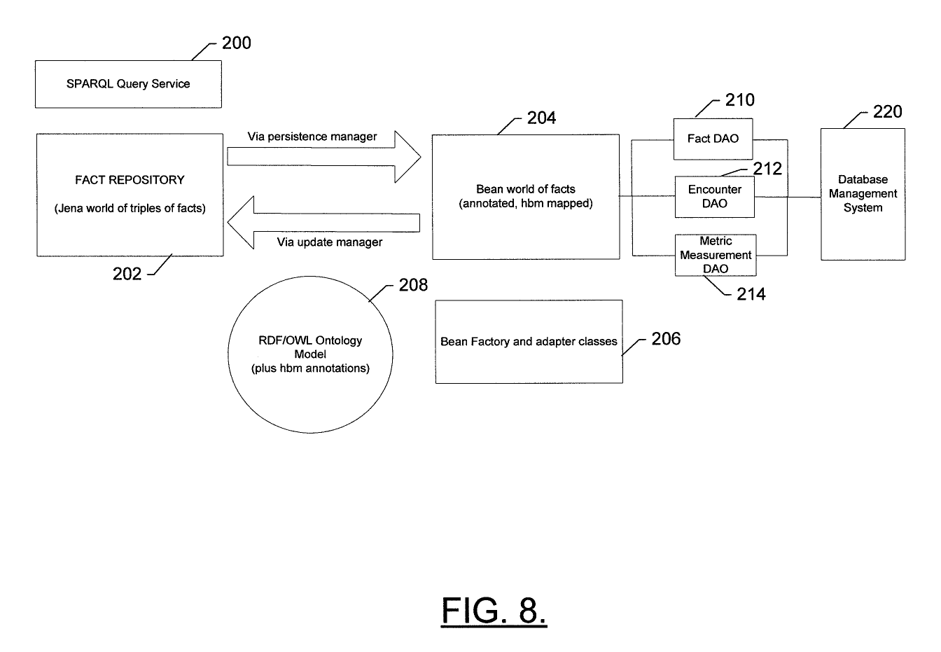

FIG. 8 illustrates a block diagram of a hybrid triple/Java bean in-memory architecture. As shown in FIG. 8, a SPARQL query service 200 may be provided to query the in-memory model. A fact repository 202 may then be provided to transform clinical data from multiple sources into the universal ontology or standard representation in the memory cache. The persistence manager may manage movement of data from the Jena world of triples of facts in the fact repository 202 to the bean world of facts 204. The update manager may facilitate the movement of data in the opposite direction. Thus, at runtime, movement may proceed in either direction. The bean world of facts 204 may map to and from a database management system 220 using a rules engine that runs against the bean world (e.g., via Hibernate).

The bean factory and adapter classes 206 may provide the bean factory for generating Java beans for the Java class hierarchy that corresponds to the clinical concept tree hierarchy of the RDF/OWL ontology model 208. The ontology model and the bean classes may be created at runtime. In some cases, a fact data access object (DAO) 210, an encounter DAO 212 and a metric measurement DAO 214 may also be included to enable the use of Hibernate or the like to focus on certain kinds of data and provide an interface between the database management system 220 (e.g., Oracle) and the Java beans.

Some embodiments of the present invention may therefore enable the use of a universal ontology or standard representation of clinical data from multiple sources. The standard representation may then be mapped to Java class implementations that can also be mapped to a relational database. The Java classes that are mapped to may not be created until runtime and therefore can be created at the customer or client site without a need to ship code to the customer or client site. By enabling mapping of standard concepts to created, on-site Java classes, the corresponding concepts may be “published” to an enterprise event bus, which may be a separate destination (perhaps for separate use cases) than the relational database. Some embodiments may also provide a mapping to associate bean types with database tables and bean properties with database columns. The mapping may enable an ontology designer to drive an entire bean definition and database mapping configuration at application runtime. Thus, for example, the process of creating beans and configuring database mappings for those beans can be fully automated based on the universal ontology. In some cases, allowances for naming differences between model entities and database entities may be accommodated by providing an external and explicit name mapping list or set of name transformation rules

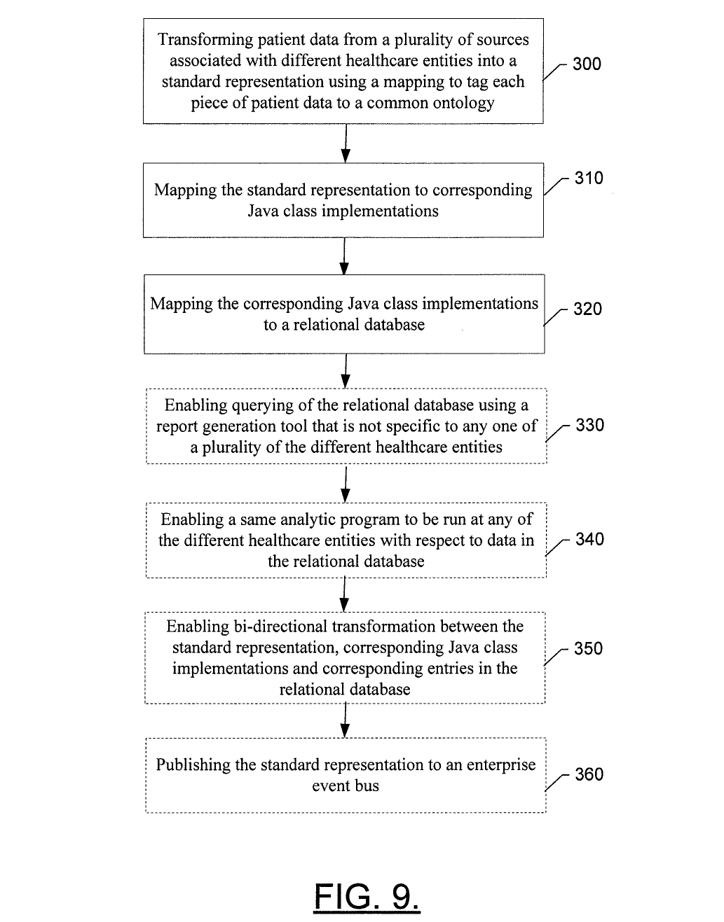

Embodiments of the present invention may therefore be practiced using an apparatus such as the one depicted in FIG. 3. However, other embodiments may be practiced in connection with a computer program product for performing embodiments of the present invention. FIG. 9 is a flowchart of a method and program product according to example embodiments of the invention. Each block or step of the flowchart of FIG. 9, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s) or step(s). These computer program instructions may also be stored in a computer-readable medium comprising memory that may direct a computer or other programmable apparatus to function in a particular manner, such that the instructions stored in the computer-readable memory produce an article of manufacture including instructions to implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

In this regard, a method according to one embodiment of the invention, as shown in FIG. 9, may include transforming patient data from a plurality of sources associated with different healthcare entities into a standard representation using a mapping to tag each piece of patient data to a common ontology at operation 300, mapping the standard representation to corresponding Java class implementations at operation 310, and mapping the corresponding Java class implementations to a relational database at operation 320.

In some cases, the method may include additional optional operations, some examples of which are shown in dashed lines in FIG. 9. The additional operations may be performed in addition to the operations described above in any order and in any combination. Thus, in some embodiments, all of the additional operations may be practiced, while in others none of the additional operations or any combination of less than all of the additional operations may be practiced. In an example embodiment, the method may further include enabling querying of the relational database using a report generation tool that is not specific to any one of a plurality of the different healthcare entities at operation 330. In some embodiments, the method may include enabling the same analytic program to be run at any of the different healthcare entities with respect to data in the relational database at operation 340. In an example embodiment, the method may further include enabling bi-directional transformation between the standard representation, corresponding Java class implementations and corresponding entries in the relational database at operation 350. In some embodiments, the method may include publishing the standard representation to an enterprise event bus at operation 360.

In some embodiments, modifications may be made to the operations described above. For example, in some cases, mapping the standard representation to the corresponding Java class implementations may include mapping the standard representation to corresponding Java beans. In an example embodiment, mapping the corresponding Java class implementations to the relational database may include utilizing mapping object-relational libraries to map the Java class implementations to a structured query language (SQL) table. In some embodiments, transforming the patient data may include transforming generic data into a strongly typed format such that mapping the corresponding Java class implementations to the relational database enables utilization of a type specific relational database for resolving database queries. In an example embodiment, mapping the standard representation to corresponding Java class implementations may include performing the mapping at a client device at runtime. In some cases, mapping the corresponding Java class implementations to the relational database may include associating bean types with database tables and associating bean properties with database columns. Other modifications are also possible. The modifications and optional operations may be included in any combination and in any order with respect to the operations 300-360 described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
transforming patient data from a plurality of sources associated with different healthcare entities into a standard representation using a mapping to tag each piece of patient data to a common ontology;
mapping the standard representation to corresponding Java class implementations; and
mapping the corresponding Java class implementations to a relational database.

2. The method of claim 1, further comprising enabling querying of the relational database using a report generation tool that is not specific to any one of a plurality of the different healthcare entities.

3. The method of claim 1, wherein mapping the standard representation to the corresponding Java class implementations comprises mapping the standard representation to corresponding Java beans.

4. The method of claim 1, wherein mapping the corresponding Java class implementations to the relational database comprises utilizing mapping object-relational libraries to map the Java class implementations to a structured query language (SQL) table.

5. The method of claim 1, wherein transforming the patient data comprises transforming generic data into a strongly typed format such that mapping the corresponding Java class implementations to the relational database enables utilization of a type specific relational database for resolving database queries.

6. The method of claim 1, further comprising enabling a same analytic program to be run at any of the different healthcare entities with respect to data in the relational database.

7. The method of claim 1, further comprising enabling bi-directional transformation between the standard representation, corresponding Java class implementations and corresponding entries in the relational database.

8. The method of claim 1, wherein mapping the standard representation to corresponding Java class implementations comprises performing the mapping at a client device at runtime.

9. The method of claim 1, further comprising publishing the standard representation to an enterprise event bus.

10. The method of claim 9, wherein mapping the corresponding Java class implementations to the relational database comprises associating bean types with database tables and associating bean properties with database columns.

11. A computer program product comprising at least one computer-readable storage medium having computer-executable program code instructions stored therein, the computer-executable program code instructions comprising program code instructions for:
transforming patient data from a plurality of sources associated with different healthcare entities into a standard representation using a mapping to tag each piece of patient data to a common ontology;
mapping the standard representation to corresponding Java class implementations; and
mapping the corresponding Java class implementations to a relational database.

12. The computer program product of claim 11, further comprising program code instructions for enabling querying of the relational database using a report generation tool that is not specific to any one of a plurality of the different healthcare entities.

13. The computer program product of claim 11, wherein program code instructions for mapping the standard representation to the corresponding Java class implementations include instructions for mapping the standard representation to corresponding Java beans.

14. The computer program product of claim 11, wherein program code instructions for mapping the corresponding Java class implementations to the relational database include instructions for utilizing mapping object-relational libraries to map the Java class implementations to a structured query language (SQL) table.

15. The computer program product of claim 11, wherein program code instructions for transforming the patient data include instructions for transforming generic data into a strongly typed format such that mapping the corresponding Java class implementations to the relational database enables utilization of a type specific relational database for resolving database queries.

16. The computer program product of claim 11, further comprising program code instructions for enabling a same analytic program to be run at any of the different healthcare entities with respect to data in the relational database.

17. The computer program product of claim 11, further comprising program code instructions for enabling bi-directional transformation between the standard representation, corresponding Java class implementations and corresponding entries in the relational database.

18. The computer program product of claim 11, wherein program code instructions for mapping the standard representation to corresponding Java class implementations include instructions for performing the mapping at a client device at runtime.

19. The computer program product of claim 11, further comprising program code instructions for publishing the standard representation to an enterprise event bus.

20. The computer program product of claim 19, wherein program code instructions for mapping the corresponding Java class implementations to the relational database include instructions for associating bean types with database tables and associating bean properties with database columns.

21. An apparatus comprising processing circuitry configured to:
transform patient data from a plurality of sources associated with different healthcare entities into a standard representation using a mapping to tag each piece of patient data to a common ontology;
map the standard representation to corresponding Java class implementations; and
map the corresponding Java class implementations to a relational database.

22. The apparatus of claim 21, wherein the processing circuitry is further configured to enable querying of the relational database using a report generation tool that is not specific to any one of a plurality of the different healthcare entities.

23. The apparatus of claim 21, wherein the processing circuitry is configured to map the standard representation to the corresponding Java class implementations by mapping the standard representation to corresponding Java beans.

24. The apparatus of claim 21, wherein the processing circuitry is configured to transform the patient data by transforming generic data into a strongly typed format such that mapping the corresponding Java class implementations to the relational database enables utilization of a type specific relational database for resolving database queries.

25. The apparatus of claim 21, wherein the processing circuitry is further configured to enable bi-directional transformation between the standard representation, corresponding Java class implementations and corresponding entries in the relational database.
